(19) United States
(12) Patent Application Publication
(10) Pub. No.: US 2024/0220795 A1
(43) Pub. Date: Jul. 4, 2024

(54) PLANNING USING A JUMPY TRAJECTORY DECODER NEURAL NETWORK

(71) Applicant: DeepMind Technologies Limited, London (GB)

(72) Inventors: Jingwei Zhang, London (GB); Arunkumar Byravan, London (GB); Jost Tobias Springenberg, London (GB); Martin Riedmiller, Balgheim (DE); Nicolas Manfred Otto Heess, London (GB); Leonard Hasenclever, London (GB); Abbas Abdolmaleki, London (GB); Dushyant Rao, London (GB)

(21) Appl. No.: 18/401,226

(22) Filed: Dec. 29, 2023

Related U.S. Application Data
(60) Provisional application No. 63/436,467, filed on Dec. 30, 2022.

(51) Int. Cl. G06N 3/08

(52) U.S. Cl. CPC G06N 3/08

(57) ABSTRACT

Methods, systems, and apparatus, including computer programs encoded on a computer storage medium, for controlling agents using jumpy trajectory decoder neural networks.

### CROSS-REFERENCE TO RELATED APPLICATION

This application claims priority to U.S. Provisional Application No. 63/436,467, filed on Dec. 30, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that uses a “jumpy” trajectory decoder neural network to (i) control an agent interacting with an environment to perform a task in the environment or (ii) assist an agent interacting with an environment to perform a task in the environment.

The trajectory decoder neural network is referred to as “jumpy” because the neural network generates predicted future trajectories for the agent that are “jumpy” versions of the future trajectory (“jumpy trajectories”). A “jumpy” version of a trajectory is one that only includes predicted state information for a proper subset of the time steps in the trajectory, so that the jumpy trajectory skips or jumps over some of the time steps in the trajectory. For example, each jumpy trajectory can include states for every k time steps in corresponding trajectory, where k is an integer greater than one. That is, any time step that has a time step index that is not a multiple of k will not have any predicted state information, e.g., a predicted observation, in the jumpy trajectory.

Particular embodiments of the subject matter described in this specification can be implemented so as to realize one or more of the following advantages.

This specification describes controlling an agent by planning using a jumpy trajectory decoder neural network. Because the trajectory decoder generates “jumpy” trajectories, the system is able to perform the planning process with reduced latency relative to conventional approaches. Moreover, because the jumpy decoder incorporates temporal abstraction, the system can effectively plan even in long-horizon tasks when conventional planning processes fail. Thus, the use of the jumpy trajectory decoder allows for more effective, lower latency control of an agent, e.g., of a robot, even in complex, real-world environments. For example, the system can use the described techniques to effectively control robots to perform complex tasks directly from image observations in a low-latency manner.

Moreover, after training the jumpy decoder neural network, the system can perform zero-shot generalization to new tasks using the trained jumpy decoder neural network or can train a downstream reinforcement learning (RL) policy using the trained jumpy decoder neural network in a computationally efficient manner.

Additionally, by training the jumpy decoder neural network jointly with learning multi-step skills, the system can learn to accurately predict the consequences of performing frequently occurring multi-step action sequences (“skills”) rather than needing to learn to predict consequences of arbitrarily chosen actions, improving the accuracy of the trained jumpy decoder neural network.

More specifically, the system can train the jumpy trajectory decoder neural network on unlabeled training trajectories (i.e., without requiring the trajectories to include any measure of task rewards). This type of data is significantly easier to collect than labeled data, greatly increasing the amount of data available for training the neural network and improving the performance of the jumpy trajectory decoder neural network after training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling an agent at a given time step.

FIG. 3 is a flow diagram of an example process for generating a candidate trajectory.

FIG. 4 shows an example process for training the trajectory decoder neural network.

FIG. 5 shows an example of the architecture of the system.

Like reference numbers and designations in the various drawings indicate like elements.

### DETAILED DESCRIPTION

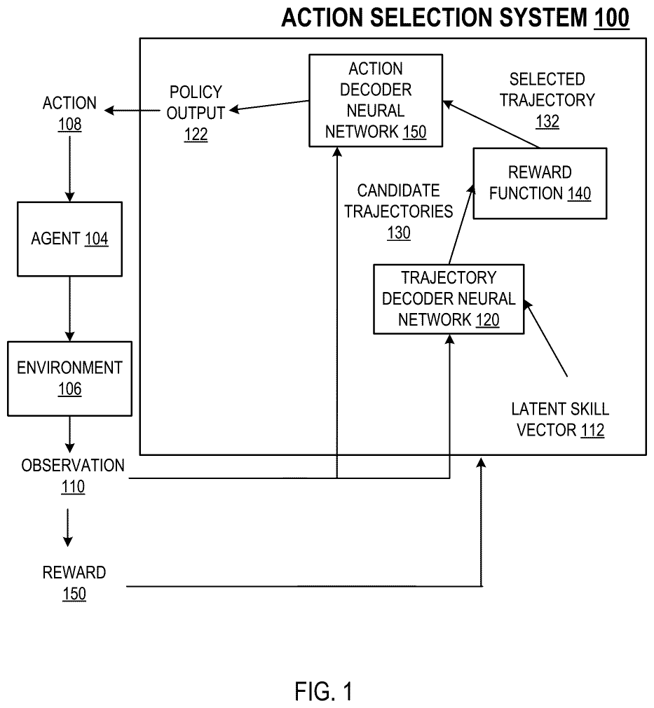

FIG. 1 shows an example action selection system 100. The action selection system 100 is an example of a system implemented as computer programs on one or more computers in one or more locations in which the systems, components, and techniques described below are implemented.

The action selection system 100 uses a “jumpy” trajectory decoder neural network 120 to (i) control an agent 104 interacting with an environment 106 to perform a task in the environment 106 or (ii) assist an agent 104 interacting with an environment 106 to perform a task in the environment 106. For example, the agent 104 can be a robot, e.g., a robotic arm, a quadruped robot, a humanoid robot, or other type of robot that is controllable by the system 100.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

In some cases, the system 100 receives an extrinsic reward 152 from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

More specifically, to control the agent 104 or to assist the agent 104 at a given time step, the system 100 receives a current observation 110 characterizing a current state of the environment 106 at the time step.

The system 100 generates a plurality of candidate future trajectories 130 that are each a respective prediction of a subset of future states in a future trajectory of the agent 104 at a plurality of future time steps.

The candidate future trajectories 130 are “jumpy” versions of the future trajectory (“jumpy trajectories”). A “jumpy” version of a trajectory is one that only includes predicted state information for a proper subset of the time steps in the trajectory, so that the jumpy trajectory skips or jumps over some of the time steps in the trajectory.

For example, each jumpy trajectory can include states for every k time steps in corresponding trajectory, where k is an integer greater than one. That is, any time step that has a time step index that is not a multiple of k will not have any predicted state information, e.g., a predicted observation, in the jumpy trajectory.

To generate a given candidate future trajectory 130, the system 100 initializes the candidate future trajectory 130 to include data characterizing the current state of the environment 106 at the current time step. The system 100 then updates the candidate future trajectory by, at each of one or more planning iterations, adding data characterizing a new state to the candidate future trajectory 130 after the last time step in the candidate future trajectory 130.

More specifically, at each of one or more planning iterations, the system 100 obtains a latent skill vector 112 for the planning iteration and processes a trajectory decoder input that includes (i) the latent skill vector for the planning iteration and (ii) data characterizing a last state identified in the candidate trajectory at a last future time step in the candidate trajectory as of the planning iteration using the trajectory decoder neural network 120 to generate a trajectory decoder output that characterizes a predicted later state of the environment.

The system 100 can obtain the skill vector by sampling the vector from a distribution, e.g., a fixed distribution that is the same for all planning iterations or a distribution that can be different for different planning iterations. The predicted later state is a state that is predicted to be a state of the environment at a later future time step in the future trajectory with there being one or more future time steps between the last future time step in the candidate trajectory and the later future time step.

That is, the trajectory decoder neural network 120 does not predict the next state at the next time step after the current last time step but instead predicts a later state that is multiple time steps into the future after the current last time step. More specifically, the predicted later state is a state that is predicted to be the state of the environment at the later future time step given that the agent 104 is controlled using the latent skill vector for the planning iteration at the last future time step and at each of the one or more future time steps that are between the last future time step and the later future time step. For example, the predicted later state can be a prediction of the state of the environment 106 given that the agent 104 is controlled, at the last future time step and at each of the one or more future time steps that are between the last future time step and the later future time step, using an action decoder neural network 150 that receives the latent skill vector for the planning iteration as input.

The trajectory decoder neural network 120 can also be referred to as a “jumpy” trajectory decoder neural network, because the later state is multiple time steps in the future relative to the state characterized in the input to the trajectory decoder neural network 120. That is, rather than generate outputs that characterize the predicted state at the time step immediately following the time step of the state characterized in the input, the trajectory decoder neural network 120 generates a “jumpy” output that characterizes a state multiple time steps into the future relative to the time step of the state characterized in the input, i.e., with multiple actions (across multiple time steps) needing to be performed in order to reach the later time step.

The system 100 then updates the candidate trajectory 130 to include data identifying the predicted next state, i.e., so that the later future time step becomes the new last time step in the candidate trajectory and the predicted next state becomes the last state at the new last time step in the candidate trajectory.

After performing the one or more planning iterations, the system 100 determines a respective task score for the candidate trajectory 130 that measures a performance of the candidate trajectory on the task.

Generally, the system 100 determines the respective task score using a reward function 140 for the task. The reward function for the task maps data characterizing a state of the environment, e.g., an observation or a predicted observation generated from the trajectory decoder output, to a reward score that represents a “reward” for the state, i.e., the progress towards completing the task that has been made when the environment is in the state.

The reward function 140 can be any appropriate reward function and can be received as input by the system 100. For example, the reward function can be a learned model that has been trained using the extrinsic rewards described above. As another example, the reward function can be a hard-coded function that operates on the input data to map the data to rewards. For example, the reward function can use a computer vision technique applied to the observation or raw sensor data present in the observation to determine the positions of objects in the environment and can apply a function that maps relative distances between objects to reward scores.

After the candidate trajectories 130 have been generated, the system 100 selects, from at least a subset of the candidate future trajectories 130, a candidate future trajectory 132 that has the highest respective task score.

When the system 100 is controlling the agent 104, the system 100 selects an action 108 to be performed by the agent 104 in response to the current observation 110 using at least the latent skill vector 112 for the first planning iteration for the selected candidate future trajectory 132 and controls the agent 104 to perform the selected action 108.

In other words, the system 100 executes a planning process using the jumpy trajectory decoder neural network 120 to generate the selected candidate future trajectory 132, which in turn informs which action is selected by the system 100 in response to the current observation 110.

Because the trajectories generated using the neural network 120 are jumpy, the system 100 can perform this planning process with reduced latency, i.e., because significantly fewer intermediate states need to be predicted in order to predict the final state of the trajectory. Moreover, because the trajectories are jumpy, the system 100 can effectively plan further into the future than conventional systems, resulting in improved planning for long-horizon tasks where the effects of actions can only be observed many time steps into the future.

For example, the system 100 can process a policy input that is derived from (i) the current observation 110 and (ii) the latent skill vector 112 obtained for the first planning iteration for the selected candidate trajectory 132 using an action decoder neural network 150 to generate a policy output 122 that defines an action to be performed in response to the current observation 112 and then select the action 108 using the policy output 122. For example, the policy input can include the latent skill vector 112 and features generated from the current observation 110. Thus, in this example, the selected candidate trajectory 122 is used to determine which latent skill vector 112 is provided as input to the neural network 150, thereby modulating the action that is selected.

As a particular example, the policy output 122 can specify a probability distribution over a set of actions to be performed by the agent 104 and the system 100 can select the action by sampling from the probability distribution or by selecting the action with the highest probability.

Examples of environments, actions, and agents that the system can control will be described in more detail below.

When the system 100 is assisting the agent 104, the system 100 provides, to the agent 108, information about how to perform the task that is generated using at least the latent skill vector for the first planning iteration for the selected candidate future trajectory 130. For example, the system 100 can use a generative neural network to map the latent skill vector to a natural language output, a speech output, an image output, or a video output, and provide the output for presentation to the agent 104.

For example, the agent that is assisted can be a human. For example assisting the agent, i.e., the human, can include communicating with a human user of a digital assistant (also referred to as a virtual assistant) such as a smart speaker or display, mobile, or other device, that implements the method.

In more detail, in some implementations the agent comprises a human user of a digital assistant such as a smart speaker, smart display, or other device. Then, information defining the task can be obtained from the digital assistant, and the digital assistant can be used to provide information to the user based on the latent vector. For example, this may comprise receiving, at the digital assistant, a request from the user for assistance and determining, in response to the request, one or more tasks for the user to perform, e.g., steps or sub-tasks of an overall task. Then for one or more tasks of the series of tasks, e.g., for each task, e.g., until a final task of the series the digital assistant can be used to output to the user information indicating how to perform the task. This may be done using natural language, e.g., on a display and/or using a speech synthesis subsystem of the digital assistant. Visual, e.g., video, and/or audio observations of the user performing the task may be captured, e.g., using the digital assistant.

As an illustrative example a user may be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses a system as described above, in particular by providing it with the captured audio and/or video to determine how the user should complete each step.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem can capture, using the observation capture subsystem, visual or audio observations of the user performing the task, determine how to perform the task, and provide information about how to perform the task.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

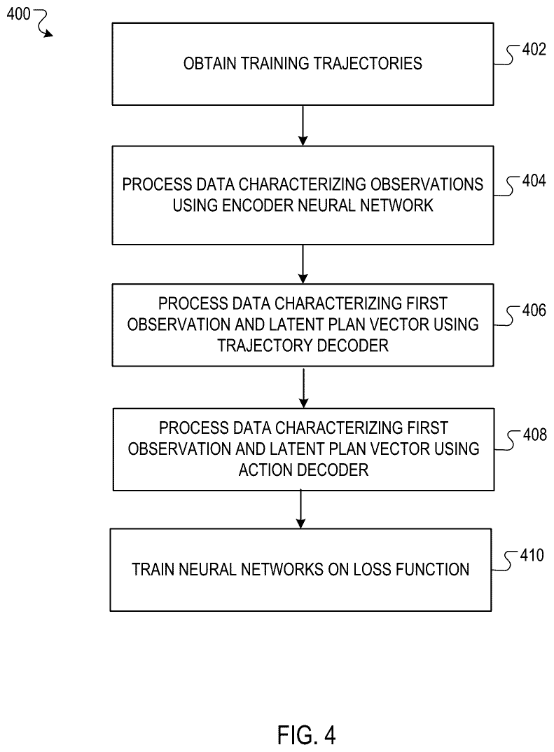

Prior to using the trajectory decoder neural network 120 to perform planning, the system 100 or another training system trains the trajectory decoder neural network 120 (and, when used, the action decoder neural network 150). This training will be described in more detail below with reference to FIG. 4.

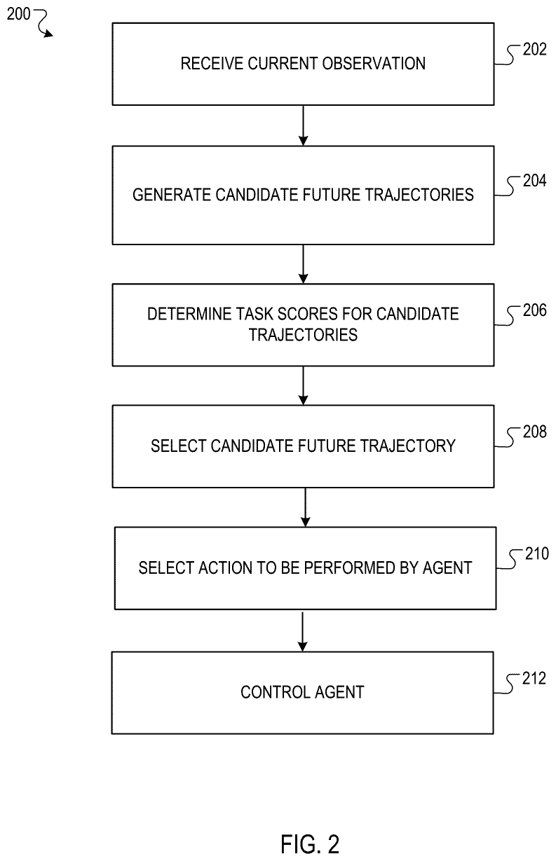

FIG. 2 is a flow diagram of an example process 200 for controlling the agent at a given time step during a task episode. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system receives a current observation characterizing a current state of the environment at the time step (step 202).

The system generates a plurality of candidate future trajectories that are each a respective prediction of a subset of future states in a future trajectory of the agent at a plurality of future time steps (step 204). Generally, as described above, the candidate future trajectories are each “jumpy” trajectories that include respective predictions for less than all of the time steps in the future trajectory.

Generating the candidate future trajectories is described in more detail below.

The system determines, for each candidate trajectory, a respective task score for the candidate trajectory that measures a performance of the candidate trajectory on the task (step 206).

For example, the system can generate the task score for a given candidate trajectory by, for each state identified in the candidate trajectory, applying a reward function for the task to data characterizing the state to generate a reward score for the state and then combining the reward scores for the states identified in the candidate trajectory. For example, the system can combine the reward scores by summing the reward scores for the states or by computing a time-discounted sum of the reward scores for the states. A “time-discounted” sum is a weighted sum in which each reward score is multiplied by a weight for the corresponding time step. For example, the weight for a given time step can be equal to a fixed discount factor (between zero and one, exclusive) raised to the power of a difference between an index of the corresponding time step and an index of the current time step.

The system selects, from at least a subset of the candidate future trajectories, a candidate future trajectory that has the highest respective task score (step 208).

In some implementations, the system selects the candidate future trajectory that has the highest respective task score among all of the candidate future trajectories.

In some other implementations, the system generates a respective subset of the candidate future trajectories at each of a sequence of cross-entropy iterations.

When performing cross-entropy iterations, for each cross-entropy iteration after the first cross-entropy iteration, the system generates parameters of the probability distributions for the planning iterations performed while generating the subset of trajectories for the cross-entropy iteration based on statistics of a first highest scoring subset of candidate future trajectories generated at the preceding cross-entropy iteration. That is, the system generates parameters of the distribution from which the latent skill vectors are sampled at a given cross-entropy iteration based on the selected latent skill vectors for the candidate trajectories that had the highest reward scores at the preceding cross-entropy iteration. Generally, the system can generate parameters that bias the distribution to assign greater likelihoods to the selected latent skill vectors for the candidate trajectories that had the one or more highest reward scores at the preceding cross-entropy iteration, e.g., by fitting the mean and standard deviation of the distribution to the one or more highest-scoring selected latent skill vectors from the preceding cross-entropy entropy.

Thus, in these implementations, the system selects, from the subset of candidate future trajectories generated at the last cross-entropy iteration, the candidate future trajectory that has a highest respective task score.

When the system is controlling the agent, the system selects an action to be performed by the agent in response to the current observation using at least the latent skill vector for the first planning iteration for the selected candidate future trajectory (step 210) and controls the agent to perform the selected action (step 212).

For example, the system can process a policy input that is derived from (i) the current observation and (ii) the latent skill vector obtained for the first planning iteration for the selected candidate trajectory using an action decoder neural network to generate a policy output that defines an action to be performed in response to the current observation and then select the action using the policy output. As a particular example, the policy output can specify a probability distribution over a set of actions to be performed by the agent and the system can select the action by sampling from the probability distribution or by selecting the action with the highest probability.

When the system does not control the agent, the system can provide, to the agent, information about how to perform the task that is generated using at least the latent skill vector for the first planning iteration for the selected candidate future trajectory.

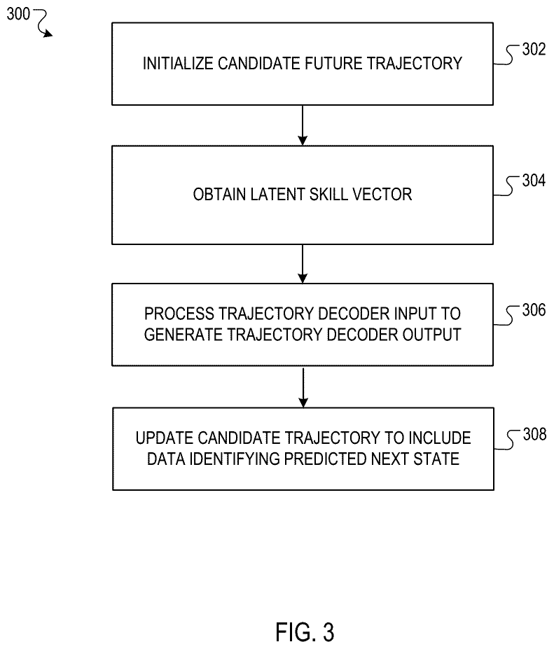

FIG. 3 is a flow diagram of an example process 300 for generating a candidate future trajectory. For convenience, the process 300 will be described as being performed by a system of one or more computers located in one or more locations. For example, an action selection system, e.g., the action selection system 100 of FIG. 1, appropriately programmed in accordance with this specification, can perform the process 300.

In some implementations, the system can parallelize the generation of the candidate future trajectories using parallel processing hardware in order to decrease the latency required for performing planning. That is, the system can generate some or all of the plurality of candidate future trajectories in parallel, e.g., by generating each candidate future trajectory on a different one of a plurality of devices or on a different core of a plurality of cores of one or more devices.

Additionally, in some implementations, rather than generating the candidate trajectories independently from one another, the system generates a respective subset of the candidate future trajectories at each of a plurality of cross-entropy iterations.

When performing cross-entropy iterations, for each cross-entropy iteration after the first cross-entropy iteration, the system generates parameters of the probability distributions for the planning iterations performed while generating the subset of trajectories for the cross-entropy iteration based on statistics of a first highest scoring subset of candidate future trajectories generated at the preceding cross-entropy iteration.

The system initializes the candidate future trajectory to include data characterizing the current state of the environment at the current time step (step 302).

The system then performs steps 302-308 at each of one or more planning iterations. In particular, at each planning iteration the system adds data characterizing a new future state to the candidate trajectory.

The system obtains a latent skill vector for the planning iteration (step 304).

For example, the system can sample the latent skill vector from a probability distribution for the planning iteration. Generally, for each planning iteration, the probability distribution for the planning iteration is a probability distribution over a space of latent skill vectors.

In some implementations, the probability distribution is a fixed prior distribution that is the same for all of the planning iterations, e.g., a uniform distribution or a Normal distribution.

In some other implementations, the system generates the probability distribution by processing the data characterizing the last state identified in the candidate trajectory, i.e., the state identified at the last future time step in the candidate trajectory as of the planning iteration, using a proposal neural network to generate a proposal output that specifies parameters of the probability distribution for the planning iteration. The parameters of the probability distribution can be, e.g., the mean and standard deviation, variance, or covariance of the distribution.

That is, the proposal neural network is a neural network that is configured to process data characterizing a state of an environment to generate an output that specifies a probability distribution over the space of latent skill vectors.

For example, the proposal neural network can have been trained through reinforcement learning (on the extrinsic rewards described above) after the action decoder neural network has been trained, i.e., so that the action decoder neural network is held fixed during the training of the proposal neural network. Thus, the proposal neural network serves as a high-level “policy” that guides how the planning process proceeds at each time step.

In yet other implementations, as described above, if the candidate trajectory is being generated during a cross-entropy iteration that is not the first in the sequence of cross-entropy iterations, the system can generate the probability distribution based on statistics of the highest-performing candidates from the preceding iteration, e.g., by fitting the mean and standard deviation of the probability distribution to the selected latent skill vectors for the one or more highest-performing candidates from the preceding iteration.

The system processes a trajectory decoder input that includes (i) the latent skill vector for the planning iteration and (ii) data characterizing the last state identified in the candidate trajectory using the trajectory decoder neural network to generate a trajectory decoder output that characterizes a predicted later state of the environment (step 306).

As described above, the predicted later state is a state that is predicted to be a state of the environment at a later future time step in the future trajectory that is more than one future time step after the last future time step in the candidate trajectory.

For example, there can be a fixed number of time steps between the last future time step in the future trajectory as of the planning iteration and the later future time step in the future trajectory, with the fixed number being greater than or equal to one. For example, the fixed number can be equal to 2, 4, 8, 10, or 16.

For example, the trajectory decoder output can define an observation characterizing the predicted later state of the environment.

In some implementations, the trajectory decoder directly regresses the observation.

In some other implementations, the trajectory decoder output defines a delta between an observation characterizing the last state identified in the candidate trajectory, i.e., the observation characterizing the state identified in the input to the trajectory decoder, and the observation characterizing the predicted later state of the environment. For example, the trajectory decoder output can be the delta between the two observations or a normalized version of the delta between the two observations. The normalized version of the delta can be, e.g., a prediction of the delta after each value in the in the delta has been normalized to have a fixed norm and variance, or a prediction of a delta between normalized versions of the two observations.

In these implementations, the system can generate the observation characterizing the predicted later state of the environment by combining the delta and the observation characterizing the last state identified in the candidate trajectory. For example, the system may need to generate the observation in order to apply the reward function to the candidate trajectory or to generate the next input to the trajectory decoder neural network for the next planning iteration.

For example, the data characterizing the last state identified in the candidate trajectory can be state features of the last state that are generated by a state encoder neural network.

In particular, for the first planning iteration, the system can process the current observation using a state encoder neural network to generate state features of the current state and include the state features as the data characterizing the last state identified in the candidate trajectory.

For any planning iterations after the first planning iteration, the data characterizing the last state identified in the candidate trajectory are state features generated using the trajectory decoder output generated at the preceding planning iteration. That is, for any planning iterations after the first planning iteration, the system can process the observation defined by the trajectory decoder output generated at the preceding planning iteration using the state encoder neural network to generate the state features.

The system then updates the candidate trajectory to include data identifying the predicted next state at the later future time step (step 308).

As described above, prior to using the trajectory decoder neural network to plan while controlling the agent, the system or another training system trains the trajectory decoder neural network.

For example, the training system can train the trajectory decoder neural network and the action decoder neural network jointly on a set of training state-action trajectories, where each of the training state-action trajectories is a sequence of observation—action pairs that each include an observation and an action performed in response to the observation, e.g., by the agent or by an expert agent, e.g., an agent controlled by a human user or by a fixed or already-learned policy.

In some implementations, as part of this training, the training system also trains an encoder neural network that is configured to process data characterizing the observations in each training state-action trajectory to generate an encoder output that defines a latent skill vector representing the training state-action trajectory.

Such a training scheme is described in more detail below with reference to FIG. 4.

FIG. 4 is a flow diagram of an example process 400 for training the trajectory decoder neural network. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system can repeatedly perform the process 400 to train the trajectory decoder neural network.

The system obtains a set of one or more training state-action trajectories (step 402). As described above, each training state-action trajectory is a sequence of at least three observation—action pairs that each include an observation characterizing a respective state of an environment and an action performed in response to the observation.

The system then performs steps 404-408 for each trajectory in the set.

The system processes data characterizing the observations in the sequence of observation—action pairs using an encoder neural network to generate an encoder output that defines a latent skill vector representing the training state-action trajectory (step 404).

For example, the system can process each observation in the state-action trajectory using the state encoder neural network to generate state features. In this example, the data characterizing the observations in the state-action trajectory can be a combination of the state features of the observations, e.g., a concatenation of or an average of the state features of the observation.

As a particular example, the encoder output can define a probability distribution over a space of latent skill vectors, e.g., can include parameters of the probability distribution.

The system processes data characterizing the first observation in the sequence of observation—action pairs and the latent skill vector representing the training state-action trajectory using the trajectory decoder neural network to generate a trajectory decoder output that characterizes a predicted later state of the environment (step 406). For example, the data characterizing the first observation in the state-action trajectory can be the state features of the first observation generated by the state encoder neural network.

For each of one or more observation—action pairs in the trajectory, the system processes an input that includes data characterizing the observation and the latent skill vector representing the training state-action trajectory using the action decoder neural network to generate a policy output (step 408).

The system then trains the encoder neural network, the trajectory decoder neural network, and the action decoder neural network (step 410). In particular, the system trains the neural networks on a loss function.

The loss function generally includes multiple terms, e.g., is a sum or a weighted sum of the multiple terms.

For example, the terms can include one term that measures, for each training state-action trajectory, a quality of the trajectory decoder output given a ground truth later state that is a state characterized by the last observation in the sequence of observation—action pairs. For example, this term can measure the log likelihood assigned to the actual observation characterizing the ground truth later state by the trajectory decoder output.

As another example, the terms can include a second term that measures, for each training state-action trajectory and for each of the one or more observation—action pairs in the trajectory, a quality of the policy output for the observation— action pair given that a ground truth action that is the action in the observation— action pair. For example, this term can measure the log likelihood assigned to the ground truth action at the time step by the corresponding policy output.

As yet another example, the loss function can include a third term that measures, for each training state-action trajectory, a divergence between the probability distribution defined by the encoder output and a prior probability distribution. The prior probability distribution can be any appropriate probability distribution, e.g., a Normal distribution or a uniform distribution.

In some implementations, the system trains the encoder neural network, the trajectory decoder neural network, the action decoder neural network, and the state encoder neural network jointly on the loss function, e.g., by backpropagating gradients of the loss function into the state encoder neural network during the training.

After the training, the system or another system can use the trained trajectory decoder neural network and the trained action decoder neural network to control an agent interacting with an environment, which can be the same environment as the one in which the training trajectories were generated or a different one. For example, the training trajectories can have been generated in simulation and the system can use the trained neural networks to control an agent in the real-world.

Optionally, as part of using the trajectory decoder neural network after the training, the system can use the trained action decoder neural network to train, through reinforcement learning, a proposal neural network that is configured to receive as input an input observation and to process the input observation to generate an output defining a latent skill vector that should be used to select an action to be performed by an agent in response to the input observation.

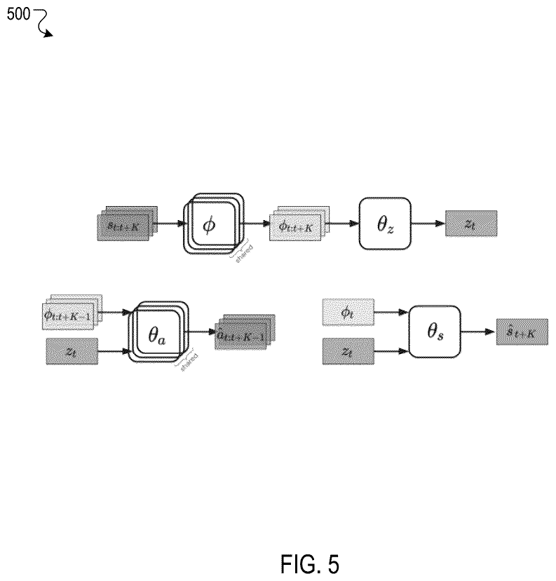

FIG. 5 shows an example architecture 500 of the system during training.

As shown in FIG. 5, the state encoder neural network encodes each observation s in a trajectory of observations from time step t to time step t+K to generate respective state features ϕ of each of the states. The encoder neural network then processes the respective state features ϕ to generate a single latent skill vector z that represents the trajectory. That is, the latent skill vector represents a high-level action (a “skill”) that is being carried across the K time steps in the trajectory (rather than a low-level action that is being performed at a single time step).

The action decoder neural network can then receive the latent skill vector z and the respective state features ϕ for time step t to time step t+K−1 and generate, for each of the time steps, a policy output that defines an action a to be performed at the time step. The policy output at each of the time steps can be compared to the actual action that was performed at the time step as part of the loss function.

Similarly, the trajectory decoder neural network receives the latent skill vector and the state features ϕ for time step t and generates a prediction of the observation s at time step t+K. That is, although the trajectory includes multiple time steps between time step t and time step t+K, the trajectory decoder neural network directly predicts the observation at time step 1+K from only the latent skill vector and the state features at time step t. The predicted observation can be compared to the actual observation at time step 1+K as part of the loss function.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

What is claimed is:

1. A method for controlling an agent interacting with an environment to perform a task, the method comprising, at each of a plurality of time steps:
receiving a current observation characterizing a current state of the environment at the time step;
generating a plurality of candidate future trajectories that are each a respective prediction of a subset of future states in a future trajectory of the agent at a plurality of future time steps, wherein generating each candidate future trajectory comprises:
initializing the candidate future trajectory to include data characterizing the current state of the environment at the current time step;
at each of one or more planning iterations:
obtaining a latent skill vector for the planning iteration;
processing a trajectory decoder input comprising (i) the latent skill vector for the planning iteration and (ii) data characterizing a last state identified in the candidate trajectory at a last future time step in the candidate trajectory as of the planning iteration using a trajectory decoder neural network to generate a trajectory decoder output that characterizes a predicted later state of the environment, wherein the predicted later state is a state that is predicted to be a state of the environment at a later future time step in the future trajectory, wherein there are one or more future time steps between the last future time step in the candidate trajectory and the later future time step, and the predicted later state is a state that is predicted to be the state of the environment at the later future time step given that the agent is controlled using the latent skill vector for the planning iteration at the last future time step and at each of the one or more future time steps that are between the last future time step and the later future time step; and
updating the candidate trajectory to include data identifying the predicted next state; and
after performing the one or more planning iterations, determining a respective task score for the candidate trajectory that measures a performance of the candidate trajectory on the task;
selecting, from at least a subset of the candidate future trajectories, a candidate future trajectory that has a highest respective task score;
selecting an action to be performed by the agent in response to the current observation using at least the latent skill vector for the first planning iteration for the selected candidate future trajectory; and
controlling the agent to perform the selected action.

2. The method of claim 1, wherein selecting an action to be performed by the agent in response to the current observation using at least the latent skill vector for the first planning iteration for the selected candidate future trajectory comprises:
processing a policy input derived from the current observation and the latent skill vector obtained for the first planning iteration for the selected candidate trajectory using an action decoder neural network to generate a policy output that defines an action to be performed in response to the current observation; and
selecting the action using the policy output.

3. The method of claim 2, wherein the policy output specifies a probability distribution over a set of actions to be performed by the agent.

4. The method of claim 1, wherein the trajectory decoder output defines an observation characterizing the predicted later state of the environment.

5. The method of claim 4, wherein the trajectory decoder output defines a delta between an observation characterizing the last state identified in the candidate trajectory and the observation characterizing the predicted later state of the environment.

6. The method of claim 5, the method further comprising:
generating the observation characterizing the predicted later state of the environment by combining the delta and the observation characterizing the last state identified in the candidate trajectory.

7. The method of claim 5, wherein the trajectory decoder output is (i) the delta or (ii) a normalized version of the delta.

8. The method of claim 1, further comprising:
processing the current observation using a state encoder neural network to generate state features of the current state, wherein:
for the first planning iteration, the data characterizing the last state identified in the candidate trajectory are the state features of the current state, and
for any planning iterations after the first planning iteration, the data characterizing the last state identified in the candidate trajectory are state features generated using the trajectory decoder output generated at the preceding planning iteration.

9. The method of claim 8, further comprising:
for any planning iterations after the first planning iteration, processing an observation defined by the trajectory decoder output generated at the preceding planning iteration using the state encoder neural network to generate the state features.

10. The method of claim 8, wherein the policy input comprises state features of the current state and the latent skill vector obtained for the first planning iteration for the selected candidate trajectory.

11. The method of claim 1, wherein obtaining a latent skill vector for the planning iteration comprises:
sampling the latent skill vector from a probability distribution for the planning iteration, the probability distribution for the planning iteration being a probability distribution over a space of latent skill vectors.

12. The method of claim 11, wherein the probability distribution is a fixed prior distribution that is the same for all of the planning iterations.

13. The method of claim 11, further comprising:
processing the data characterizing the last state identified in the candidate trajectory at the last future time step in the candidate trajectory as of the planning iteration using a proposal neural network to generate a proposal output that specifies parameters of the probability distribution for the planning iteration.

14. The method of claim 1, wherein determining a respective task score for the candidate trajectory that measures a performance of the candidate trajectory on the task comprises:
for each state identified in the candidate trajectory, applying a reward function for the task to data characterizing the state to generate a reward score for the state; and
combining the reward scores for the states identified in the candidate trajectory.

15. The method of claim 14, wherein combining the reward scores comprises:
computing a time-discounted sum of the reward scores for the states.

16. The method of claim 1, wherein generating a plurality of candidate future trajectories comprises generating the plurality of candidate future trajectories in parallel.

17. The method of claim 16, wherein each candidate future trajectory is generated on a different one of a plurality of devices or on a different core of a plurality of cores of one or more devices.

18. The method of claim 1, wherein selecting, from at least a subset of the candidate future trajectories, a candidate future trajectory that has a highest respective task score comprises:
selecting, from the plurality of candidate future trajectories, a candidate future trajectory that has a highest respective task score.

19. The method of claim 1, wherein generating a plurality of candidate future trajectories comprises:
generating a respective subset of the candidate future trajectories at each of a plurality of cross-entropy iterations.

20. The method of claim 19, further comprising:
for each cross-entropy iteration after the first cross-entropy iteration, generating parameters of probability distributions for the planning iterations performed while generating the subset of trajectories for the cross-entropy iteration based on statistics of a first highest scoring subset of candidate future trajectories generated at the preceding cross-entropy iteration.

21. The method of claim 19, wherein selecting, from at least a subset of the candidate future trajectories, a candidate future trajectory that has a highest respective task score comprises:
selecting, from the subset of candidate future trajectories generated at the last cross-entropy iteration, a candidate future trajectory that has a highest respective task score.

22. The method of claim 1, wherein there are a fixed number of time steps between the last future time step in the future trajectory as of the planning iteration and the later future time step in the future trajectory, the fixed number is greater than or equal to one, and wherein the trajectory decoder output is generated given that the agent is controlled using the latent skill vector for the planning iteration at the last future time step and at each of the fixed number of time steps.

23. The method of claim 2, wherein the trajectory decoder neural network and the action decoder neural network have been trained jointly on a set of training state-action trajectories, each training state-action trajectories being a sequence of observation—action pairs that each include an observation and an action performed in response to the observation.

24. The method of claim 23, wherein the trajectory decoder neural network and the action decoder neural network have been trained jointly with an encoder neural network that is configured to process data characterizing the observations in each training state-action trajectory to generate an encoder output that defines a latent skill vector representing the training state-action trajectory.

25. A system comprising one or more computers and one or more storage devices storing instructions that when executed by the one or more computers cause the one or more computers to perform operations for controlling an agent interacting with an environment to perform a task, the operations comprising, at each of a plurality of time steps:
receiving a current observation characterizing a current state of the environment at the time step;
generating a plurality of candidate future trajectories that are each a respective prediction of a subset of future states in a future trajectory of the agent at a plurality of future time steps, wherein generating each candidate future trajectory comprises:
initializing the candidate future trajectory to include data characterizing the current state of the environment at the current time step;
at each of one or more planning iterations:
obtaining a latent skill vector for the planning iteration;
processing a trajectory decoder input comprising (i) the latent skill vector for the planning iteration and (ii) data characterizing a last state identified in the candidate trajectory at a last future time step in the candidate trajectory as of the planning iteration using a trajectory decoder neural network to generate a trajectory decoder output that characterizes a predicted later state of the environment, wherein the predicted later state is a state that is predicted to be a state of the environment at a later future time step in the future trajectory, wherein there are one or more future time steps between the last future time step in the candidate trajectory and the later future time step, and the predicted later state is a state that is predicted to be the state of the environment at the later future time step given that the agent is controlled using the latent skill vector for the planning iteration at the last future time step and at each of the one or more future time steps that are between the last future time step and the later future time step; and
updating the candidate trajectory to include data identifying the predicted next state; and
after performing the one or more planning iterations, determining a respective task score for the candidate trajectory that measures a performance of the candidate trajectory on the task;
selecting, from at least a subset of the candidate future trajectories, a candidate future trajectory that has a highest respective task score;
selecting an action to be performed by the agent in response to the current observation using at least the latent skill vector for the first planning iteration for the selected candidate future trajectory; and
controlling the agent to perform the selected action.

26. One or more non-transitory computer storage media storing instructions that when executed by one or more computers cause the one or more computers to perform operations for controlling an agent interacting with an environment to perform a task, the operations comprising, at each of a plurality of time steps:
receiving a current observation characterizing a current state of the environment at the time step;
generating a plurality of candidate future trajectories that are each a respective prediction of a subset of future states in a future trajectory of the agent at a plurality of future time steps, wherein generating each candidate future trajectory comprises:
initializing the candidate future trajectory to include data characterizing the current state of the environment at the current time step;
at each of one or more planning iterations:
obtaining a latent skill vector for the planning iteration;
processing a trajectory decoder input comprising (i) the latent skill vector for the planning iteration and (ii) data characterizing a last state identified in the candidate trajectory at a last future time step in the candidate trajectory as of the planning iteration using a trajectory decoder neural network to generate a trajectory decoder output that characterizes a predicted later state of the environment, wherein the predicted later state is a state that is predicted to be a state of the environment at a later future time step in the future trajectory, wherein there are one or more future time steps between the last future time step in the candidate trajectory and the later future time step, and the predicted later state is a state that is predicted to be the state of the environment at the later future time step given that the agent is controlled using the latent skill vector for the planning iteration at the last future time step and at each of the one or more future time steps that are between the last future time step and the later future time step; and
updating the candidate trajectory to include data identifying the predicted next state; and
after performing the one or more planning iterations, determining a respective task score for the candidate trajectory that measures a performance of the candidate trajectory on the task;
selecting, from at least a subset of the candidate future trajectories, a candidate future trajectory that has a highest respective task score;
selecting an action to be performed by the agent in response to the current observation using at least the latent skill vector for the first planning iteration for the selected candidate future trajectory; and
controlling the agent to perform the selected action.
